(19) United States
(12) Patent Application Publication
(10) Pub. No.: US 2008/0211404 A1
(43) Pub. Date: Sep. 4, 2008

(54) PLASMA DISPLAY PANEL, AND METHOD OF DRIVING AND MANUFACTURING THE SAME

(75) Inventors: Moonshick CHUNG, Pohang-si (KR); Youngjoon AHN, Gumi-si (KR); Juwon SEO, Gwangyang-si (KR); BongKoo KANG, Pohang-si (KR); Suchang LEE, Gyoungsangbuk-do (KR); Myungje JUN, Pohang-si (KR)

Correspondence Address: FISH & RICHARDSON P.C., P.O. BOX 1022, MINNEAPOLIS, MN, 55440-1022, US

(73) Assignee: LG ELECTRONICS INC., Seoul (KR)

(21) Appl. No.: 11/859,189

(22) Filed: Sep. 21, 2007

(30) Foreign Application Priority Data
Mar. 2, 2007 (KR) 10-2007-0021100
Mar. 7, 2007 (KR) 10-2007-0022302
Mar. 7, 2007 (KR) 10-2007-0022303

(51) Int. Cl. H01J 17/49; G09G 5/00

(52) U.S. Cl. 313/582; 345/206

(57) ABSTRACT

A plasma display panel and method of driving the panel is disclosed. The plasma display panel includes a front substrate, a rear substrate that is positioned opposite to the front substrate and a phosphor layer positioned between the front substrate and the rear substrate. The phosphor layer includes particles of phosphor material and particles of oxide material. The oxide material particles are positioned in the phosphor layer in such a manner that illumination at the front surface from at least one phosphor material particle in the phosphor layer is unobstructed by the oxide material particles.

This disclosure claims the benefit of Korean Patent Application Nos. 10-2007-0021100, 10-2007-0022302 and 10-2007-0022303 filed on Mar. 2, 2007, Mar. 7, 2007 and Mar. 7, 2007, respectively, which are hereby incorporated by reference.

### BACKGROUND

1. Field

This disclosure relates to a plasma display panel and a method of driving and manufacturing the same.

2. Description of Related Art

A plasma display panel includes a phosphor layer positioned inside discharge cells partitioned by barrier ribs, and a plurality of electrodes.

Driving signals are supplied to the discharge cells through the plurality of electrodes, thereby generating a discharge inside the discharge cell. During the generation of the discharge, a discharge gas filled in the discharge cell generates vacuum ultraviolet rays, which thereby cause the phosphor layer to emit light, thus generating visible light. An image is displayed on the screen of the plasma display panel through visible light.

### SUMMARY

In one general aspect, a plasma display panel includes a front substrate, a rear substrate that is positioned opposite to the front substrate, and a phosphor layer positioned between the front substrate and the rear substrate. The phosphor layer includes particles of phosphor material and particles of oxide material. The oxide material particles are positioned in the phosphor layer in such a manner that illumination at the front surface from at least one phosphor material particle in the phosphor layer is unobstructed by the oxide material particles.

In another general aspect, a plasma display panel includes a front substrate, a rear substrate that is positioned opposite to the front substrate, and a means for emitting light based on discharge generated between the front substrate and the rear substrate. The light emitting means is positioned between the front substrate and the rear substrate and includes particles of phosphor material and particles of oxide material. The oxide material particles are positioned in the light emitting means in such a manner that illumination at the front surface from at least one phosphor material particle in the light emitting means is unobstructed by the oxide material particles.

Implementations may include one or more of the following features. For example, the oxide material particles may be positioned between the phosphor material particles. Also, at least one oxide particle may be isolated from other oxide material particles. Alternatively or additionally, at least one oxide particle may be fully obstructed. At least one of the oxide material particles may be positioned below at least one of the phosphor material particles. The oxide material particles may form an oxide material particle layer having a non-uniform thickness.

The oxide material includes at least one of magnesium oxide (MgO), zinc oxide (ZnO), silicon oxide (SiO2), titanium oxide (TiO2), yttrium oxide (Y2O3), aluminum oxide (Al2O3), lanthanum oxide (La2O3), iron oxide, europium oxide (EuO) or cobalt oxide. The ratio of the size of the oxide material particles to the size of the phosphor material particles may range from 0.005 to 1.0 or from 0.05 to 0.25. The size of the oxide material particles may range from 20 nm to 3,000 nm.

In another general aspect, a method of driving a plasma display panel includes supplying a scan driving voltage to a scan electrode of the plasma display panel during at least one subfield of a frame, supplying a sustain driving voltage to a sustain electrode of the plasma display panel during the one subfield of the frame, and supplying an address driving voltage to an address electrode of the plasma display panel during the one subfield of the frame. The scan, sustain and address driving voltages control generation of discharge which causes illumination from a phosphor layer of the plasma display panel. The phosphor layer includes particles of phosphor material and particles of oxide material. The oxide material particles are positioned in the phosphor layer in such a manner that illumination from at least one phosphor material particle in the phosphor layer is unobstructed by the oxide particles. The oxide material particles effect at least one waveform of the scan, sustain and address driving voltages.

Implementations may include one or more of the following features. For example, during an address period of the one subfield, the scan driving voltage may be increased from a first voltage to a second voltage, maintained at the second voltage, decreased from the second voltage to a third voltage, maintained at the third voltage, increased from the third voltage to the second voltage and maintained at the second voltage. Also, during the address period, the address driving voltage may be increased from a forth voltage to a fifth voltage, maintained at the fifth voltage and decreased from the fifth voltage to the forth voltage. The magnitude of a difference between the forth voltage and the fifth voltage may range from 0.5 to 6 times a magnitude of a difference between the first voltage and the third voltage.

Alternatively, during an address period of the one subfield, the scan driving voltage may be increased from a first voltage to a second voltage, maintained at the second voltage, decreased from the second voltage to a third voltage, maintained at the third voltage, increased from the third voltage to the second voltage and maintained at the second voltage. Also, the magnitude of a difference between the first voltage and the third voltage may range from 35V to 45V.

Other features will be apparent from the following description, including the drawings, and the claims.

### BRIEF DESCRIPTION OF THE DRAWINGS

FIG. 1 illustrates the structure of a plasma display panel according to one implementation;

FIG. 2 illustrates a phosphor layer within the structure of FIG. 1;

FIG. 3 illustrates structures of phosphor layers;

FIG. 4 illustrates the relationship among luminance, process difficulty and the size of oxide particles;

FIG. 5 illustrates one exemplary method for manufacturing a phosphor layer;

FIGS. 6a and 6b illustrate another exemplary method for manufacturing a phosphor layer;

FIG. 7 illustrates a frame for achieving a gray level of an image in the plasma display panel according to one implementation;

FIG. 8 illustrates one example of a driving method of the plasma display panel according to one implementation during one subfield of a frame;

FIG. 9 illustrates waveforms of light emission and a scan signal;

FIGS. 10a and 10b illustrate a slope of a rising signal and its relationship with the address discharge stability;

FIGS. 11a and 11b are voltage waveforms on a scan electrode;

FIG. 12 is another voltage waveform on the scan electrode;

FIGS. 13a and 13b are waveforms of rising signals during different subfields;

FIG. 14 illustrates another waveforms of the rising signal;

FIG. 15 illustrates voltage waveforms on scan electrode and address electrode;

FIG. 16 illustrates waveforms for a sustain period;

FIG. 17 illustrates waveforms of signals supplied to the address electrode, scan electrode and sustain electrode;

FIGS. 18a and 18b are signal waveforms supplied during a reset period and schematic diagrams of discharge forms generated during the reset period;

FIG. 19 illustrates signal waveforms supplied to the scan electrode and the sustain electrode; and

FIG. 20 illustrates signal waveforms supplied to the scan electrode and the address electrode during the reset period.

### DETAILED DESCRIPTION

Oxide particles may be included within the phosphor material of a phosphor layer within a plasma display panel, improve secondary electron emission characteristics, enabling the use of a lower discharge voltage, and improving luminance. Moreover, it is possible to regulate the desire for a lower driving voltage against the desire to enhance occlusion that may occur if particles used to achieve the lower driving voltage are positioned between the phosphors and the viewing surface or if they are too numerous relative to the phosphor particles that they help to drive. Specifically, in at least one described implementation, while oxide particles are positioned within (or before) the phosphor layer to decrease the driving voltage otherwise required to inspire excitation of the phosphor particles, their number and position is balanced against the desire to maximize luminance from the phosphor particles. Thus, contemplated is a balance between the need to increase the amount/density/size of oxide particles within a phosphor particle layer, and hence to reduce driving voltage for that layer, and the need to maximize luminance generated by the layer being driven. In yet more detail, it is possible to increase the oxide particle amount (e.g., number of oxide particles, or number of particles per volume/weight), the oxide particle size (e.g., the size of each oxide particle), and/or the oxide particle density (e.g., ratio of oxide particles to phosphor particles), and to regulate one or more of these metrics against the occlusion impacts of oxide particles within the phosphor layer, which may be measured in terms of decreased luminance during the excitation phase of the phosphor particle layer.

Similarly, oxide particles may be placed within the phosphor particle layer to minimize their occlusion effects. Described are various configurations that place the oxide particles within, between, beneath and around phosphor particles or the phosphor particle layer itself.

FIG. 1 illustrates the structure of an exemplary plasma display panel 100 that includes a front substrate 101 and a rear substrate 111 which are opposite to and coalesced with each other. On the front substrate 101, a scan electrode 102 and a sustain electrode 103 are disposed in parallel to each other. On the rear substrate 111, ◯ an address electrode 113 is disposed to intersect the scan electrode 102 and the sustain electrode 103.

An upper dielectric layer 104 for covering the scan electrode 102 and the sustain electrode 103 is disposed on an upper portion of the front substrate 101 on which the scan electrode 102 and the sustain electrode 103 are disposed.

The upper dielectric layer 104 limits discharge currents of the scan electrode 102 and the sustain electrode 103, and provides insulation between the scan electrode 102 and the sustain electrode 103.

A protective layer 105 is disposed on an upper surface of the upper dielectric layer 104 to improve discharge conditions. The protective layer 105 includes a material having a high secondary electron emission coefficient, for example, magnesium oxide (MgO).

A lower dielectric layer 115 for covering the address electrode 113 is disposed on the rear substrate 111 on which the address electrode 113 is disposed. The lower dielectric layer 115 provides insulation for the address electrode 113.

Barrier ribs 112, which may be a stripe type, a well type, a delta type, a honeycomb type, and the like, are disposed on an upper portion of the lower dielectric layer 115 to partition discharge spaces (i.e., discharge cells). A red (R) discharge cell, a green (G) discharge cell, and a blue (B) discharge cell, and the like, are disposed between the front substrate 101 and the rear substrate 111.

In addition to the red (R), green (G), and blue (B) discharge cells, a white (W) discharge cell or a yellow (Y) discharge cell may be further disposed between the front substrate 101 and the rear substrate 111.

The widths of the red (R), green (G), and blue (B) discharge cells may be substantially equal to one another. Alternatively, the width of at least one of the red (R), green (G), or blue (B) discharge cells may be different from the widths of the other discharge cells.

For instance, the width of the red (R) discharge cell may be the smallest, and the widths of the green (G) and blue (B) discharge cells may be greater than the width of the red (R) discharge cell. The width of the green (G) discharge cell may be substantially equal to the width of the blue (B) discharge cell. Alternatively, the width of the green (G) discharge cell may be different from the width of the blue (B) discharge cell.

The widths of the above-described discharge cells determine the width of a phosphor layer 114 disposed inside the discharge cells. For example, the width of a blue (B) phosphor layer disposed inside the blue (B) discharge cell may be greater than the width of a red (R) phosphor layer disposed inside the red (R) discharge cell. The width of a green (G) phosphor layer disposed inside the green (G) discharge cell may be greater than the width of the red (R) phosphor layer disposed inside the red (R) discharge cell.

As a result, a color temperature characteristic of an image displayed on the plasma display panel is improved.

The plasma display panel may have various forms of barrier rib structures other than the structure of the barrier rib 112 illustrated in FIG. 1. For instance, although the barrier rib 112 in FIG. 1 includes a first barrier rib 112b and a second barrier rib 112a with the same height, the barrier rib 112 may have a differential type barrier rib structure in which the height of the first barrier rib 112b and the height of the second barrier rib 112a are different from each other.

In the differential type barrier rib structure, the height of the first barrier rib 112b may be less than the height of the second barrier rib 112a.

While the plasma display panel has been illustrated and described to have the red (R), green (G), and blue (B) discharge cells arranged on the same line, it is possible to arrange them in a different pattern. For instance, a delta type arrangement in which the red (R), green (G), and blue (B) discharge cells are arranged in a triangle shape may be applicable. Further, the discharge cells may form a variety of polygonal shapes, such as rectangular, pentagonal, and hexagonal shapes.

While in the plasma display panel in FIG. 1, the barrier rib 112 is disposed on the rear substrate 111, the barrier rib 112 may alternatively be disposed on the front substrate 101.

Each of the discharge cells partitioned by the barrier ribs 112 is filled with a discharge gas.

The phosphor layer 114 for emitting visible light for an image display during the generation of an address discharge is disposed inside the discharge cells partitioned by the barrier ribs 112. For instance, red (R), green (G) and blue (B) phosphor layers may be disposed inside the discharge cells.

A white (W) phosphor layer and/or a yellow (Y) phosphor layer may be further disposed in addition to the red (R), green (G) and blue (B) phosphor layers.

The thickness of at least one of the phosphor layers 114 disposed inside the red (R), green (G) and blue (B) discharge cells may be different from the thicknesses of the other phosphor layers. For instance, the thicknesses of green (G) and blue (B) phosphor layers inside the green (G) and blue (B) discharge cells may be greater than the thickness of a red (R) phosphor layer inside the red (R) discharge cell. The thickness of the green (G) phosphor layer inside the green (G) discharge cell may be substantially equal to or different from the thickness of the blue (B) phosphor layer inside the blue (B) discharge cell.

It should be noted that only one example of the plasma display panel has been illustrated and described, the present invention is not limited to the plasma display panel of the above-described structure. For instance, while the above description illustrates a case where the upper dielectric layer 104 and the lower dielectric layer 115 each are formed in the form of a single layer, at least one of the upper dielectric layer 104 and the lower dielectric layer 115 may be formed in the form of a plurality of layers.

A black layer (not shown) for absorbing external light may be further disposed on the upper portion of the barrier rib 112 to prevent the reflection of the external light caused by the barrier rib 112. Further, the black layer may be disposed at a specific position of the front substrate 101 corresponding to the barrier rib 112.

The address electrode 113 disposed on the rear substrate 111 may have a substantially constant width or thickness. Alternatively, the width or thickness of the address electrode 113 inside the discharge cell may be different from the width or thickness of the address electrode 113 outside the discharge cell. For instance, the width or thickness of the address electrode 113 inside the discharge cell may be greater than the width or thickness of the address electrode 113 outside the discharge cell.

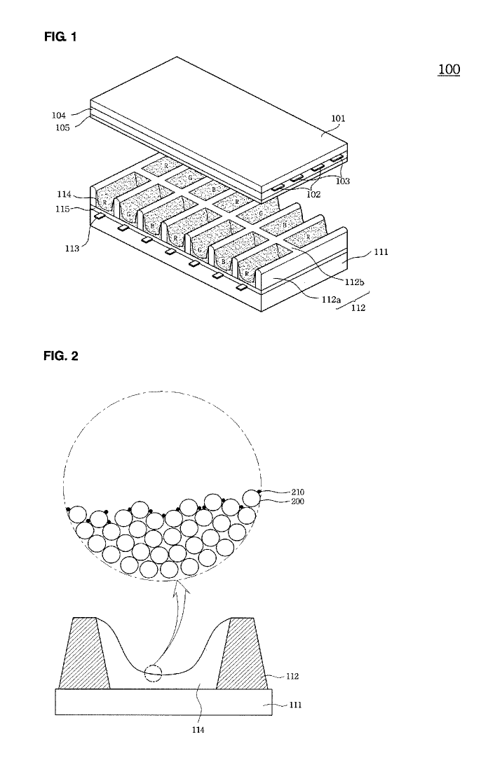

FIG. 2 illustrates the structure of a phosphor layer.

Referring to FIG. 2, the phosphor layer 114 includes a phosphor material and an oxide material. On the surface of the phosphor layer 114, oxide particles 210 are disposed between phosphor particles 200.

Since the oxide particles 210 are disposed between the phosphor particles 200, a discharge response characteristic between the scan electrode and the address electrode or between the sustain electrode and the address electrode is improved.

Examples of the oxide material include at least one of magnesium oxide (MgO), zinc oxide (ZnO), silicon oxide (SiO₂), titanium oxide (TiO₂), yttrium oxide (Y₂O₃), aluminum oxide (Al₂O₃), lanthanum oxide (La₂O₃), iron oxide, europium oxide (EuO) or cobalt oxide.

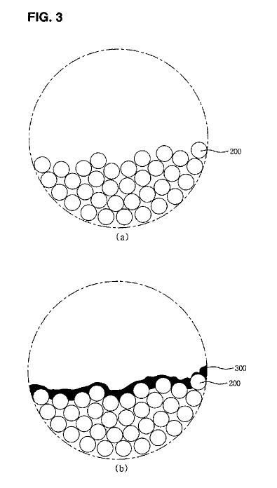

FIG. 3 illustrates other types of phosphor layers.

FIG. 3 illustrates a phosphor layer without any oxide particles, as represented by (a) in FIG. 3.

When a discharge is generated between the scan electrode and the address electrode or between the sustain electrode and the address electrode during the driving of the plasma display panel, charges are distributed on the surface of the phosphor particles 200 on the surface of the phosphor layer.

For the phosphor layer as represented by (a) in FIG. 3, most of the charges are distributed in specific portions of the phosphor layer due to the non-uniform height of the phosphor layer. This results in the generation of a strong discharge in the specific portions of the phosphor layer. For example, when a discharge is generated between the scan electrode and the address electrode, most of charges are distributed in the specific portion of the phosphor layer due to a driving signal applied to the address electrode, thereby generating a strong discharge between the specific portion of the phosphor layer and the scan electrode.

Accordingly, since the relatively strong discharge is generated in the specific portion of the phosphor layer in which most of charges are distributed, a contrast characteristic worsens. Furthermore, since the intensity of the discharge or the main generation portion of the discharge may be different in each discharge cell, it is necessary to increase a driving voltage to uniformize a discharge characteristic in each discharge cell. However, this may further worsen the contrast characteristic.

On the other hand, as illustrated in FIG. 2, when the oxide particles 210 are disposed between the phosphor particles 200, a discharge is uniform and stable. For example, when a discharge is generated between the scan electrode and the address electrode, the oxide particles 210 function as a catalyst of the discharge. Therefore, the discharge between the scan electrode and the address electrode is stably generated at a lower driving voltage than the driving voltage for the phosphor layer without any oxide particles. This is because the discharge is generated near the oxide particles 210 at a relatively low voltage due to an electrical property of the oxide material. The generated discharge is diffused to cover the phosphor particles 200.

FIG. 3 also illustrates a case where an oxide layer 300 covering the phosphor particles 200 is disposed, as represented by (b) in FIG. 3. To cover the phosphor particles, after forming the phosphor layer, the surface of the phosphor layer is coated with the oxide layer 300 using a deposition method, and the like.

When such a phosphor layer is used, a discharge is generated uniformly and stably between the scan electrode and the address electrode or the sustain electrode and the address electrode due to the electrical property of the oxide layer 300. However, since the phosphor particles 200 are covered with the oxide layer 300, visible light emitted from the phosphor particles 200 is blocked, thereby excessively reducing luminance.

In contrast, as illustrated in FIG. 2, when the oxide particles 210 are disposed between the phosphor particles 200, the oxide particles 210 do not cover the phosphor particles 200 and therefore, do not block the light emitted from the phosphor particles 200. At the same time, a discharge between the scan electrode and the address electrode or between the sustain electrode and the address electrode is generated stably.

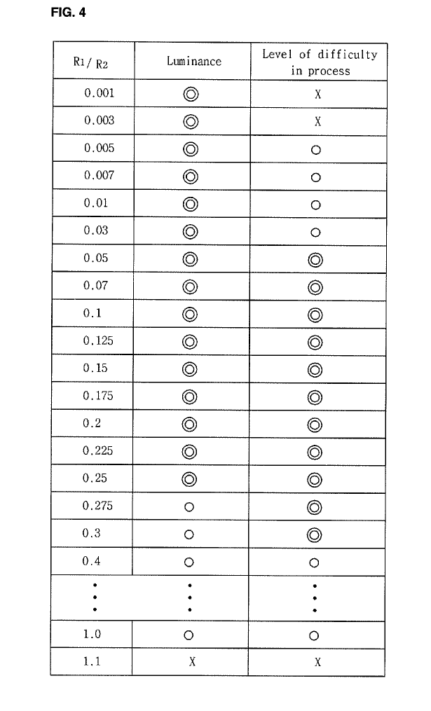

The size of the oxide particles 210 may be more or less than the size of the phosphor particles 200. FIG. 4 illustrates the relationship among the size of oxide particles, luminance and the level of the difficulty of the oxide treatment process.

In FIG. 4, R1 denotes the size of oxide particles, and R2 denotes the size of phosphor particles. The size may be a diameter or a length, and the like.

FIG. 4 explains how the luminance and the level of difficulty of the oxide treatment process are effected by a change in the size of the oxide particles relative to the size of the phosphor particles. In FIG. 4, ⊚ indicates that the luminance or the level of difficulty are in “excellent” condition, ◯ indicates “good” condition, and X indicates being “poor” condition.

Referring to FIG. 4, when a ratio of the size R1 of the oxide particles to the size R2 of the phosphor particles ranges from 0.001 to 0.25 (i.e., when the size R1 of the oxide particles is sufficiently less than the size R2 of the phosphor particles), it is to easy position the oxide particles between the phosphor particles such that the emission path of the visible light from the phosphor particles is sufficiently well secured. Accordingly, a luminance is marked with ⊚ indicating “excellent” luminance.

When a ratio of the size R1 of the oxide particles to the size R2 of the phosphor particles ranges from 0.275 to 1.0, a luminance is marked with ◯ indicating “good” luminance.

On the other hand, when the size R1 of the oxide particles is more than the size R2 of the phosphor particles, the oxide particles intercepts the emission path of visible light from the phosphor particles. Accordingly, the luminance is poor, as indicated by mark X in FIG. 4.

When a ratio of the size R1 of the oxide particles to the size R2 of the phosphor particles ranges from 0.001 to 0.003 times, the level of difficulty in a treatment process of the oxide particles is high and marked with X. In such a case, sine the size R1 of the oxide particles is excessively less than the size R2 of the phosphor particles, the oxide particles are not covering the phosphor particles and are mostly positioned between the phosphor particles or inside the phosphor layer. Accordingly, the discharge between the scan electrode and the address electrode or between the sustain electrode and the address electrode is generated stably.

When a ratio of the size R1 of the oxide particles to the size R2 of the phosphor particles ranges from 0.005 to 0.03 or from 0.4 to 1.0, the level of difficulty in process is good, as marked with ◯ in FIG. 4.

When a ratio of the size R1 of the oxide particles to the size R2 of the phosphor particles ranges from 0.05 to 0.3, the size R1 of the oxide particles is optimized such that the level of difficulty in process is low (or excellent) as marked with ⊚ in FIG. 4. In this case, most of the oxide particles are positioned between the phosphor particles on the surface of the phosphor layer such that the discharge between the scan electrode and the address electrode or between the sustain electrode and the address electrode is generated stably.

Accordingly, it is advantageous that a ratio of the size R1 of the oxide particles to the size R2 of the phosphor particles ranges from 0.005 to 1.0. It is more advantageous that a ratio of the size R1 of the oxide particles to the size R2 of the phosphor particles ranges from 0.05 to 0.25. For example, the size of oxide particles ranges from 20 nm to 3,000 nm.

Although FIG. 4 has illustrated and described a case where the size R1 of the oxide particles is relatively less than the size R2 of the phosphor particles, the size R1 of the oxide particles may be greater than the size R2 of the phosphor particles.

The oxide particles may have one orientation or two or more different orientations.

For example, in a case of MgO, only (200)-oriented MgO may be used, or (200), (220), and (111)-oriented MgO may be used.

The orientation of the oxide particles may vary depending on various conditions such as the discharge gas, the phosphor material, and the voltage magnitude of the driving signal.

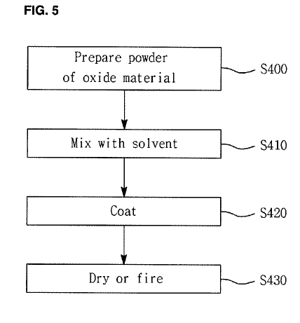

FIG. 5 illustrates one exemplary method for manufacturing a phosphor layer.

As illustrated in FIG. 5, first, a powder of oxide material is prepared in step S400. For example, MgO powder is obtained by performing a gas oxidation process using Mg vapor which may be generated by heating Mg.

Next, the prepared oxide power is mixed with a solvent in step S410. For example, the MgO powder prepared in step $400 is mixed with methanol to make, for example, oxide paste or oxide slurry.

Subsequently, the oxide material mixed with the solvent is coated on an upper portion of the phosphor layer in step S420. In this case, the viscosity of the oxide material is adjusted to properly position the oxide particles between the phosphor particles.

Subsequently, a drying process or a firing process is performed in step S430. Then, the solvent mixed with the oxide material is evaporated such that the oxide particles are positioned between the phosphor particles.

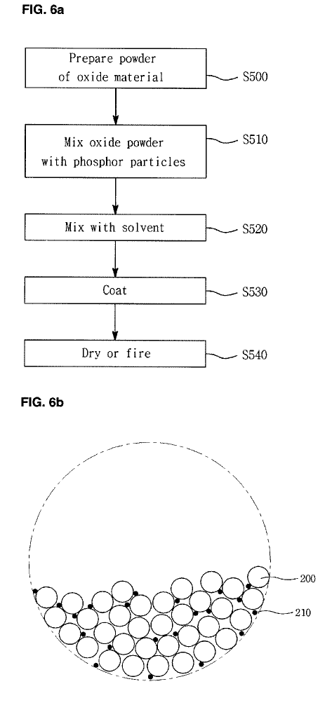

FIGS. 6a and 6b illustrate another exemplary method for manufacturing a phosphor layer.

As illustrated in FIG. 6a, a powder of oxide material is prepared in step S500.

The prepared oxide power is mixed with phosphor particles in step S510.

The oxide power, the phosphor particles are mixed with a solvent in step S520.

The oxide power and the phosphor particles mixed with the solvent are coated inside discharge cells in step S530. A dispensing method may be used.

A drying process or a firing process is performed in step S540. Then, the solvent is evaporated such that the oxide particles 210 are positioned between the phosphor particles 200 as illustrated in FIG. 6b.

Unlike FIG. 5, the oxide particles are positioned between the phosphor particles on the surface and in the inside of the phosphor layer in FIGS. 6a and 6b.

As above, when the oxide particles are positioned between the phosphor particles on the surface and in the inside of the phosphor layer, a discharge response characteristic between the scan electrode and the address electrode or between the sustain electrode and the address electrode is improved.

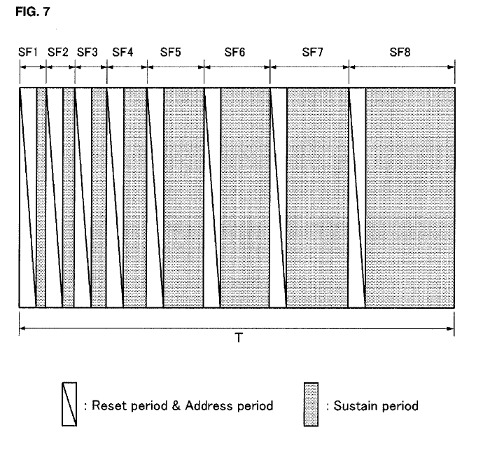

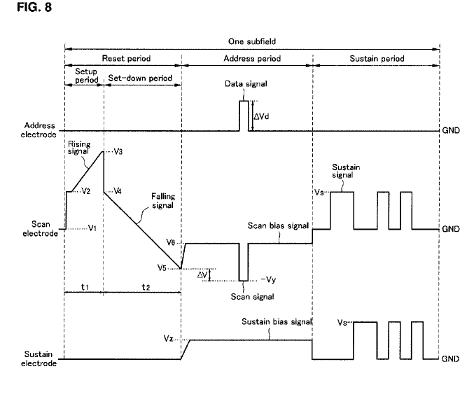

FIG. 7 illustrates a frame for achieving a gray level of an image in a plasma display panel.

Referring to FIG. 7, the frame is divided into a plurality of subfields each having a different duration.

At least one subfield of the plurality of subfields is subdivided into a reset period during which all discharge cells are initialized, an address period during which discharge cells to be discharged are selected, and a sustain period during which a gray level is represented in accordance with the number of discharges.

For example, in order to display 256 gray levels, a frame, as illustrated in FIG. 7, is divided into 8 subfields SF1 to SF8. Each of the 8 subfields SF1 to SF8 is subdivided into a reset period, an address period, and a sustain period.

The number of sustain signals supplied during the sustain period determines a gray level weight of each of the subfields. For example, in order to set the gray level weight of a first subfield to 2⁰ and the gray level weight of a second subfield to 2¹, the sustain period increases in a ratio of 2ⁿ (where, n=0, 1, 2, 3, 4, 5, 6, 7) in each of the subfields. Since the sustain period varies from one subfield to the next subfield, a specific gray level is achieved by combining proper subfields to emit light among the 8 subfields, each of which includes a sustain period with different durations.

The plasma display panel according to one implementation uses a plurality of frames to display an image during 1 second. For example, 60 frames are used to display an image during 1 second. In this case, a length T of one frame may be 1/60 seconds, i.e., 16.67 ms.

Although FIG. 7 has illustrated and described a case where one frame includes 8 subfields, the number of subfields constituting one frame may vary. For example, one frame may include 12 subfields or 10 subfields.

Further, although FIG. 7 has illustrated and described the subfields arranged in increasing order of gray level weight, the subfields may be arranged in decreasing order of gray level weight, or the subfields may be arranged regardless of gray level weight.

FIG. 8 illustrates one example of a driving method of the plasma display panel during one subfield of a frame.

Referring to FIG. 8, a reset signal may be supplied to the scan electrode during a reset period. The reset signal may include a rising signal and a falling signal. The reset period is further divided into a setup period and a set-down period.

During the setup period, a rising signal is supplied to the scan electrode. The rising signal sharply rises from a first voltage V1 to a second voltage V2, and then gradually rises from the second voltage V2 to a third voltage V3. The first voltage V1 may be equal to the ground level voltage GND.

The rising signal generates a weak dark discharge (i.e., a setup discharge) inside the discharge cell during the setup period, thereby accumulating a proper amount of wall charges inside the discharge cell.

During the set-down period, a falling signal is supplied to the scan electrode.

The falling signal gradually falls from a fourth voltage V4, which is lower than the highest voltage (i.e., the third voltage V3) of the rising signal, to a fifth voltage V5.

The falling signal generates a weak erase discharge (i.e., a set-down discharge) inside the discharge cell. Furthermore, the remaining wall charges are uniform inside the discharge cells so that an address discharge can be stably performed.

During an address period, the voltage at the scan electrode maintains at a sixth voltage V6, which is higher than the lowest voltage (i.e., the fifth voltage V5) of the falling signal, then falls from the sixth voltage to a scan signal voltage (as denoted by −Vy in FIG. 8), and then rises to and maintains at the sixth voltage

The width of a scan signal supplied to the scan electrode (i.e., the time duration during which the scan signal voltage is maintained at the scan electrode) during an address period of at least one subfield may be different from the width of a scan signal supplied to the scan electrode during an address period of another subfield. For example, in the subfield arrangement of FIG. 7, the width of the scan signal for each subfield may be gradually reduced in the order of 2.6 μs, 2.3 μs, 2.1 μs, 1.9 μs, etc., or in the order of 2.6 μs, 2.3 μs, 2.3 μs, 2.1 μs, 1.9 μs, 1.9 μs, etc.

When the scan signal is supplied to the scan electrode, a data signal corresponding to the scan signal is supplied to the address electrode.

As the voltage difference between the scan signal and the data signal is added to the wall voltage generated during the reset period, the address discharge is generated inside the discharge cell to which the data signal is supplied.

A sustain bias signal is supplied to the sustain electrode during the address period to prevent the generation of the unstable address discharge caused by the interference of the sustain electrode.

The sustain bias signal is substantially maintained at a sustain bias voltage Vz. The sustain bias voltage Vz is lower than a sustain voltage Vs of a sustain signal supplied during a sustain period, and is higher than the ground level voltage GND.

During the sustain period, sustain signals or sustain pulses are supplied to the scan electrode and the sustain electrode.

As the wall voltage within the discharge cell selected by performing the address discharge is added to the sustain voltage Vs of the sustain signal, every time the sustain pulse is supplied, the sustain discharge, i.e., a display discharge occurs between the scan electrode and the sustain electrode.

As illustrated in FIG. 8, sustain pulses are supplied during a sustain period of at least one subfield. The width of at least one of the sustain pulses may be different from the widths of the remaining sustain pulses. For example, the width of the sustain pulse, which is first supplied during the sustain period, may be greater than the width of the other sustain pulses, so that a sustain discharge is generated more stably.

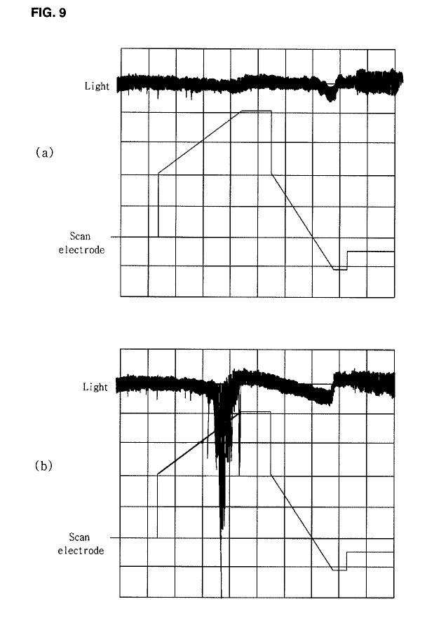

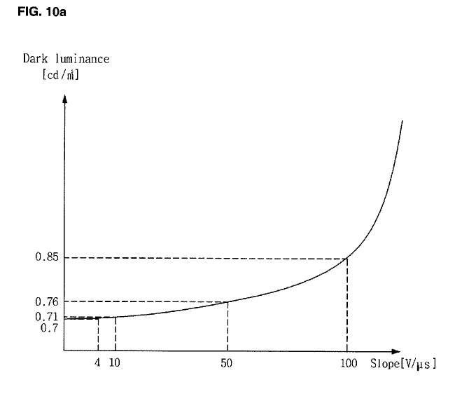

FIG. 9 illustrates waveforms of light emission and scan signals to explain the effect of an oxide material. In FIG. 9, the waveform represented by (a) illustrates a case where the phosphor layer includes an oxide material, and the waveform represented by (b) illustrates a case where the phosphor layer does not include an oxide material.

Referring to FIG. 9, when the rising signal is supplied to the scan electrode during the reset period, a discharge is generated between the scan electrode and the address electrode. However, in a case where the phosphor layer does not include the oxide material as represented by (b) in FIG. 9, charges are mostly distributed in a specific portion of the phosphor layer and accordingly, a strong discharge is generated between the specific portion and the scan electrode. Therefore, the light intensity generated during the reset period sharply increases, thereby resulting in a degradation of the contrast characteristic.

On the other hand, in a case where the phosphor layer includes the oxide material as represented by (a) in FIG. 9, the discharge response characteristic between the scan electrode and the address electrode is improved and therefore, a discharge is generated at a lower driving voltage than when the phosphor layer does not include any oxide material. Furthermore, the light intensity generated during the reset period does not change sharply, thereby improving the contrast characteristic.

When the phosphor layer does not include any oxide material, a surface discharge is mainly generated between the scan electrode and the sustain electrode during the reset period. When the phosphor layer includes the oxide material, an opposite discharge is mainly generated between the scan electrode and the address electrode. Accordingly, a stable weak discharge is generated, and therefore, the contrast and the luminance are improved.

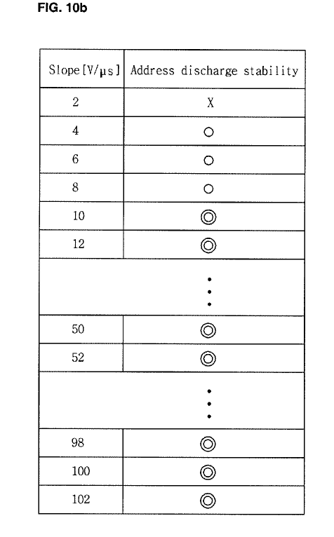

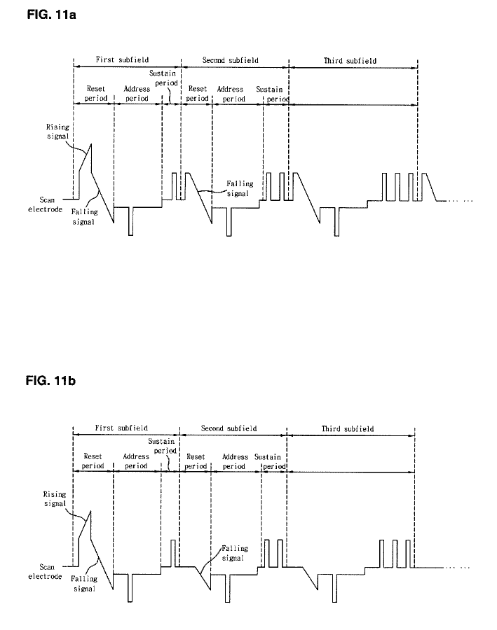

FIGS. 10a and 10b illustrate a slope of a rising signal and its relationship with the address discharge stability.

Referring to FIG. 10a, when a slope of the rising signal supplied to the scan electrode during the reset period is more than 100 V/μs, the intensity of a discharge generated between the scan electrode and the address electrode sharply increases. This results in a sharp increase in a luminance of light (referred to as a dark luminance) generated during the reset period.

On the other hand, when the slope of the rising signal ranges from 50 V/μs to 100 V/μs, the intensity of the discharge generated between the scan electrode and the address electrode is stable such that a dark luminance has a relatively low value ranging from 0.76 cd/m² to 0.85 cd/m².

When the slope of the rising signal ranges from 10 V/μs to 50 V/μs, the intensity of a discharge generated between the scan electrode and the address electrode is stable such that a dark luminance has a stable value ranging from 0.71 cd/m² to 0.76 cd/m². When the slope of the rising signal ranges from 4 V/μs to 10 V/μs, a dark luminance has a more stable value ranging from 0.70 cd/m² to 0.71 cd/m².

When the slope of the rising signal is equal to or less than 4 V/μs, a dark luminance is about 0.70 cd/m².

FIG. 10b explains the relationship between the slope of the rising signal on the scan electrode during the reset period and the stability of an address discharge generated by the scan signal and the data signal during the address period. The slope of the rising signal during the reset period affects the address discharge stability because the slope affects the duration of the reset period, which affects the duration of the address period. In FIG. 10b, ⊚ indicates the stability being “excellent”, ◯ indicates “good”, and X indicates “poor”.

Referring to FIG. 10b, when the slope of the rising signal is equal to or less than 2 V/μs, the duration of the reset period excessively lengthens such that the length of the address period excessively shortens. Therefore, the scan signal does not have the sufficient width and accordingly, the address discharge stability is poor.

On the other hand, when the slope of the rising signal ranges from 4 V/μs to 8 V/μs, the durations of the reset period and the address period are proper such that the address discharge stability is good.

Further, when the slope of the rising signal is equal to or more than 10 V/μs, the duration of the reset period sufficiently shortens, providing enough time for the address period. Therefore, the scan signal may have sufficient width such that the address discharge stability is excellent.

To stabilize the address discharge and to sufficiently lower the dark luminance during the reset period, as illustrated in FIGS. 10a and 10b, it is advantageous that the slope of the rising signal ranges from 4 V/μs to 100 V/μs. It is more advantageous that the slope of the rising signal ranges from 10 V/μs to 50 V/μs.

As above, when the slope of the rising signal ranges from 4 V/μs to 100 V/μs or from 10 V/μs to 50 V/μs, as illustrated in FIG. 8, a length t1 of the setup period is relatively shorter than a length t2 of the set-down period and the length of the address period sufficiently increases. Accordingly, the scan signal may have the sufficient width such that sufficiently stable address discharge is generated.

When the slope of the rising signal ranges from 4 V/μs to 100 V/μs or from 10 V/μs to 50 V/μs such that wall charges are stably distributed during the reset period, the amount of voltage decrease of the falling signal supplied during the set-down period is relatively reduced. In other words, the lowest voltage V5 of the falling signal is heightened such that the length of the set-down period shortens.

Further, the wall charges are stably distributed inside the discharge cell during the reset period. Therefore, although a voltage magnitude ΔVd of the data signal is relatively small, a sufficiently stable address discharge is generated.

When the voltage magnitude ΔVd of the data signal is excessively small, the intensity of the address discharge becomes excessively weak. On the other hand, when the voltage magnitude ΔVd of the data signal is excessively large, the wall charges inside the discharge cell are erased such that sustain discharge may not be generated despite the supply of the sustain signal. Therefore, it is advantageous that the voltage magnitude ΔVd of the data signal ranges from 0.5 to 6 times a difference between the lowest voltage −Vy of the scan signal and the lowest voltage V5 of the falling signal.

A difference ΔV between the lowest voltage −Vy of the scan signal and the lowest voltage V5 of the falling signal may range from 35V to 45V.

FIGS. 11a and 11b illustrate a case where a rising signal is omitted.

In FIG. 11a, the supply of a rising signal is omitted during a reset period of at least one subfield.

For example, a rising signal and a falling signal are supplied during a reset period of a first subfield of a relatively low gray level weight. The supply of a rising signal is omitted and only a falling signal is supplied during reset periods of second and third subfields of higher gray level weight than the first subfield.

In FIG. 11a, before supplying the falling signal during the reset period in the second and third subfields, a voltage on the scan electrode rises to a predetermined voltage that is equal to or more than the ground level voltage. However, as illustrated in FIG. 11b, the falling signal may be directly supplied at an end of a sustain period of a previous subfield, without rising the voltage to the predetermined voltage as illustrated in FIG. 11a.

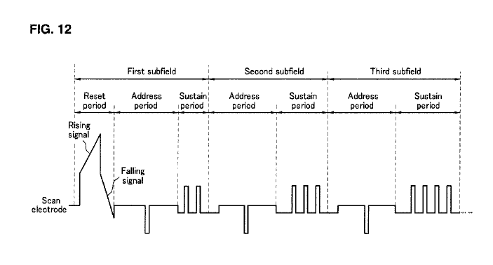

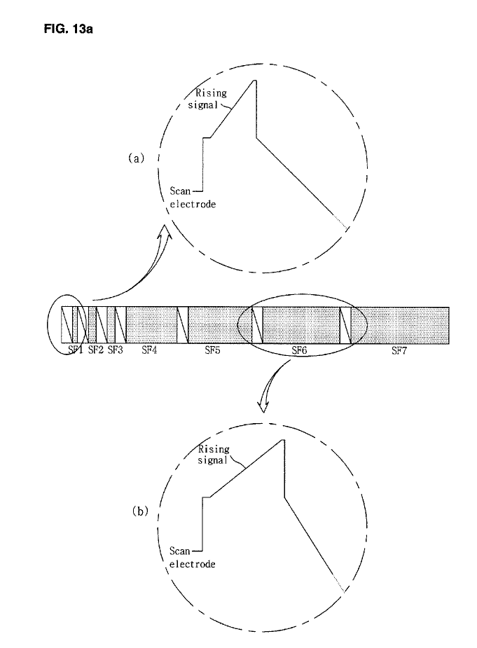

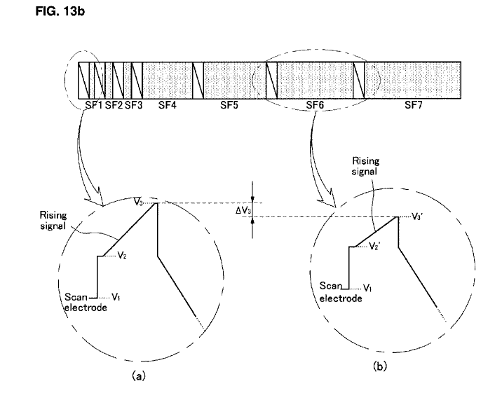

FIG. 12 illustrates a case where a reset signal is omitted.

Referring to FIG. 12, a reset signal including a rising signal and a falling signal is supplied to the scan electrode during a reset period of a first subfield of relatively low gray level weight. A reset period is omitted in second and third subfields of higher gray level weight than the first subfield.

FIGS. 13a and 13b illustrate one exemplary driving method of supplying rising signals with different slopes during different subfields.

It is assumed that one frame includes a total of 7 subfields SF1 to SF7 and the 7 subfields SF1 to SF7 are arranged in increasing order of gray level weight.

In FIG. 13a, slopes of rising signals in two different subfields may be different from each other. For example, a slope of a rising signal supplied to the scan electrode in the first subfield SF1, as represented by (a) in FIG. 13a, is greater than a slope of a rising signal supplied to the scan electrode in the sixth subfield SF6, as represented by (b) in FIG. 13a.

Further, the method as illustrated in FIG. 13a may be combined with the methods as illustrated in FIGS. 11 and 12, where the supply of the rising signal or the supply of the reset signal is omitted.

Referring to FIG. 13b, a peak voltage of the rising signal supplied to the scan electrode during a reset period of at least one subfield may be different from a peak voltage of the rising signal supplied to the scan electrode during a reset period of another subfield. For example, a peak voltage V3 of a rising signal supplied to the scan electrode in the first subfield SF1, as represented by (a) in FIG. 13b, is greater than a peak voltage V3′ of a rising signal supplied to the scan electrode in the sixth subfield SF6, as represented by (b) in FIG. 13b, by a voltage magnitude ΔV3.

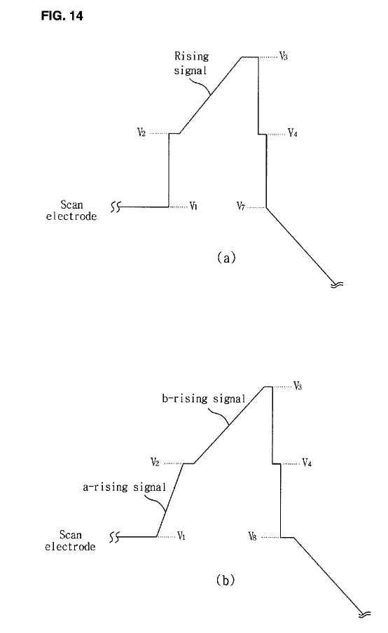

FIG. 14 illustrates another forms of a reset signal.

Referring to the waveform as represented by (a) in FIG. 14, a falling signal gradually falls from a seventh voltage V7, that is lower than the forth voltage V4. The seventh voltage V7 may be substantially equal to the first voltage V1.

Referring to the waveform as represented by (b) in FIG. 14, a rising signal includes an a-rising signal and a b-rising signal each having a different rising slope.

When a slope of the b-rising signal is less than a slope of the a-rising signal, the voltage of the rising signal rises relatively rapidly until the setup discharge occurs, and the voltage of the rising signal rises relatively slowly during the generation of the setup discharge. As a result, the light intensity generated by the setup discharge is reduced, thereby improving the contrast characteristic.

An eighth voltage V8 in the waveform (b) in FIG. 14 may be substantially equal to the seventh voltage V7 in the waveform (a) in FIG. 14.

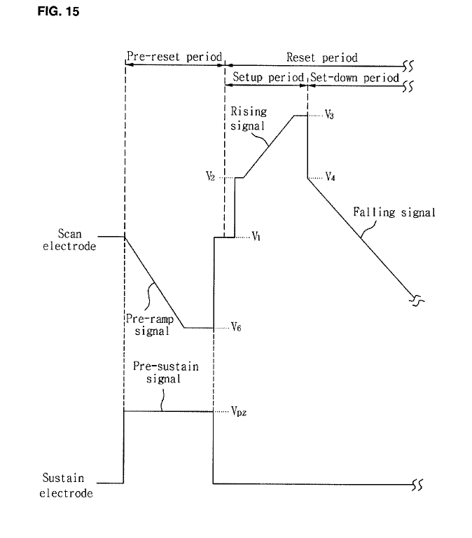

FIG. 15 illustrates a case where one subfield includes a pre-reset period.

The subfield may include a pre-reset period prior to the reset period. As illustrated in FIG. 15, the subfield further includes a pre-reset period prior to the reset period. During the pre-reset period, a pre-ramp signal gradually falling to a sixth voltage V6 is supplied to the scan electrode.

During the supplying of the pre-ramp signal to the scan electrode, a pre-sustain signal is supplied to the sustain electrode.

The pre-sustain signal is constantly maintained at a pre-sustain voltage Vpz. The pre-sustain voltage Vpz may be substantially equal to the voltage (i.e., the sustain voltage Vs) of the sustain signal supplied during a sustain period.

As above, during the pre-reset period, the pre-ramp signal is supplied to the scan electrode and the pre-sustain signal is supplied to the sustain electrode. As a result, wall charges of a predetermined polarity are accumulated on the scan electrode, and wall charges of a polarity opposite the polarity of the wall charges accumulated on the scan electrode are accumulated on the sustain electrode. For example, wall charges of a positive polarity are accumulated on the scan electrode, and wall charges of a negative polarity are accumulated on the sustain electrode.

As a result, a setup discharge with a sufficient strength occurs during the reset period such that the initialization of all the discharge cells is performed stably.

Furthermore, because of the pre-reset period, even when the slope of the rising signal supplied to the scan electrode during the reset period is relatively low, a setup discharge with a sufficient strength occurs.

Only one subfield of one frame may include a pre-reset period prior to a reset period, so as to obtain sufficient driving time. Alternatively, two or three subfields may include a pre-reset period prior to a reset period.

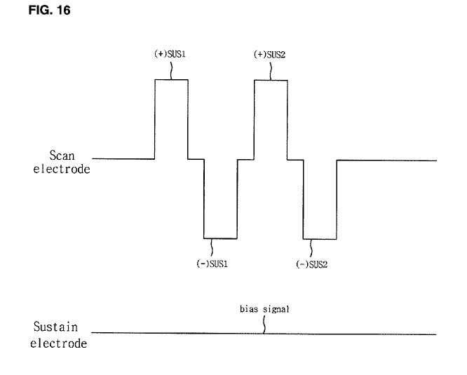

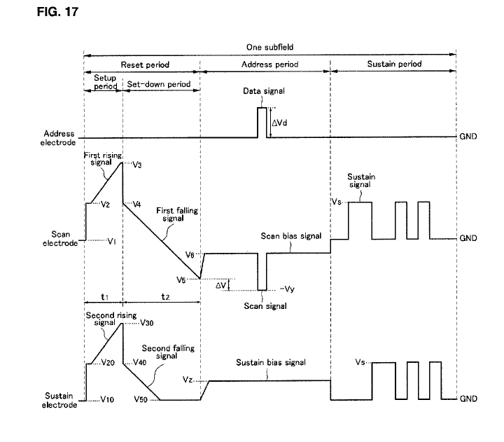

FIG. 16 illustrates another form of a sustain signal.

As illustrated in FIG. 16, a positive sustain voltage and a negative sustain voltage are alternately supplied to the scan electrode.

When the positive sustain voltage and the negative sustain voltage are alternately supplied to the scan electrode, a bias signal is supplied to the sustain electrode.

The bias signal is constantly maintained at the ground level voltage GND.

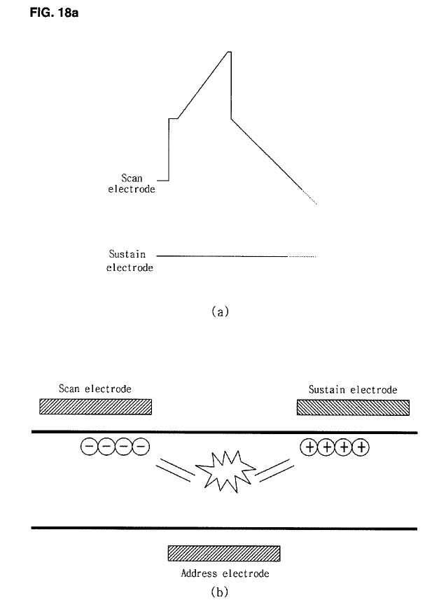

FIG. 17 illustrates a case where a rising signal is supplied to a scan electrode and a sustain electrode during a reset period.

Referring to FIG. 17, a first rising signal with a gradually rising voltage is supplied to the scan electrode, and a second rising signal with a gradually rising voltage is supplied to the sustain electrode during a reset period. The first rising signal and the second rising signal are supplied simultaneously.

The second rising signal supplied to the sustain electrode gradually rises from a twentieth voltage V20 to a thirtieth voltage V30.

After supplying the first rising signal to the scan electrode, a first falling signal with a gradually falling voltage is supplied to the scan electrode. Further, after supplying the second rising signal to the sustain electrode, a second falling signal gradually falling from a fortieth voltage V40 to a fiftieth voltage V50 is supplied to the sustain electrode.

The fortieth voltage V40 may be the ground level voltage GND.

A slope of the first falling signal may be equal to or different from a slope of the second falling signal.

As illustrated in FIG. 17, the two reset signals supplied to the scan electrode and the sustain electrode during the reset period include the rising signal and the falling signal, and have a similar shape. In the waveforms as illustrated in FIG. 17, the voltages V1 and V10 may be substantially equal, the voltages V2 and V20 may be substantially equal, the voltages V3 and V30 may be substantially equal, and the voltages V4 and V40 may be substantially equal. Two slopes of the two rising signals may be substantially equal, and two slopes of the two falling signals may be substantially equal.

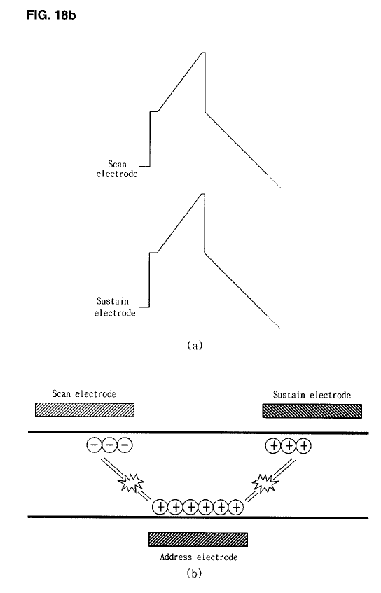

FIGS. 18a and 18b explains how signal waveforms supplied during the reset period affects discharge types generated during the reset period.

Referring to waveforms (a) in FIG. 18a, a rising signal is supplied to the scan electrode and a rising signal is not supplied to the sustain electrode during the reset period.

In this case, as represented by (b) in FIG. 18a, a reset discharge mainly occurs between the scan electrode and the sustain electrode during the reset period.

Since the reset discharge mainly occurs between the scan electrode and the sustain electrode during the reset period, wall charges are accumulated on the scan electrode and the sustain electrode to some extent, and are then erased. Therefore, the remaining wall charges are uniform inside the discharge cells.

However, since the address discharge occurs between the scan electrode and the address electrode during the address period, a state of wall charges distributed in the discharge cells during the reset period may be different from a state of wall charges required during the address period.

Accordingly, in FIG. 18a, after sufficiently erasing the wall charges during the reset period, it is necessary to accumulate the wall charges again during the address period.

In FIG. 18b, rising signals are supplied to the scan electrode and the sustain electrode during the reset period, respectively. In this case, as represented by (b) in FIG. 18b, a reset discharge occurs between the scan electrode and the address electrode and between the sustain electrode and the address electrode during the reset period.

In FIG. 18b, a state of wall charges distributed in the discharge cells during the reset period is similar to a state of wall charges required during the address period. Therefore, the address discharge occurs during the address period using the state of the wall charges distributed during the reset period. Furthermore, a voltage magnitude (as represented by ΔVd in FIG. 17) of the data signal in FIG. 18b is less than a voltage magnitude ΔVd of the data signal in FIG. 18a.

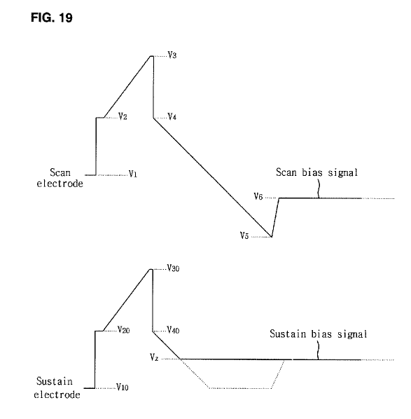

FIG. 19 illustrates another form of a second falling signal.

Referring to FIG. 19, the second falling signal supplied to the sustain electrode during the reset period gradually falls from a voltage (for example, the voltage V40), that is lower than the peak voltage V30 of the second rising signal, to the voltage Vz of the sustain bias signal.

When the sustain bias signal is supplied at an end of the second falling signal, as illustrated in FIG. 19, the number of switching operations in the driving circuit decreases thereby decreasing the generation of heat in the driving circuit.

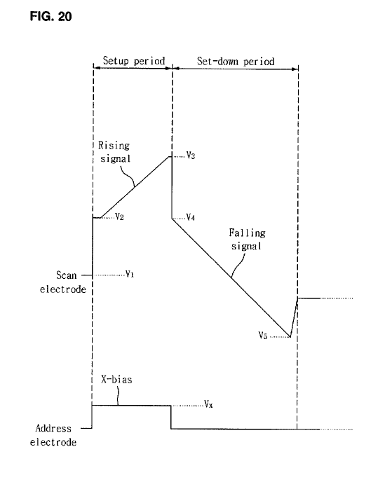

FIG. 20 illustrates an exemplary case where an address bias signal is supplied.

Referring to FIG. 20, an address bias signal (X-bias) is supplied to the address electrode during a reset period of at least one subfield. In this case, the voltage difference between the scan electrode and the address electrode or the voltage difference between the sustain electrode and the address electrode during the reset period is reduced such that the reset discharge is generated more stably.

Although FIG. 20 illustrates the address bias signal supplied during a setup period of the reset period, the address bias signal may be supplied during a set-down period of the reset period, or during the setup period and the set-down period.

Further, although the address bias signal is substantially maintained at a specific voltage (for example a voltage Vx) in the example of FIG. 20, the address bias signal may be a ramp waveform or a triangle waveform.

Other implementations are within the scope of the following claims.

What is claimed is:

1. A plasma display panel comprising:
a front substrate;
a rear substrate that is positioned opposite to the front substrate; and
a phosphor layer positioned between the front substrate and the rear substrate, the phosphor layer including particles of phosphor material and particles of oxide material, the oxide material particles being positioned in the phosphor layer in such a manner that illumination at the front surface from at least one phosphor material particle in the phosphor layer is unobstructed by the oxide material particles.

2. The plasma display panel of claim 1, wherein the oxide material particles are positioned between the phosphor material particles.

3. The plasma display panel of claim 2, wherein at least one oxide particle is isolated from other oxide material particles.

4. The plasma display panel of claim 1, wherein at least one oxide material particle is fully obstructed.

5. The plasma display panel of claim 1, wherein at least one of the oxide material particles is positioned below at least one of the phosphor material particles.

6. The plasma display panel of claim 1, wherein the oxide material particles form an oxide material particle layer having a non-uniform thickness.

7. The plasma display panel of claim 1, wherein the oxide material includes at least one of magnesium oxide (MgO), zinc oxide (ZnO), silicon oxide (SiO₂), titanium oxide (TiO₂), yttrium oxide (Y₂O₃), aluminum oxide (Al₂O₃), lanthanum oxide (La₂O₃), iron oxide, europium oxide (EuO) or cobalt oxide.

8. The plasma display panel of claim 7, wherein the oxide material includes at least one of magnesium oxide (MgO), zinc oxide (ZnO), or titanium oxide (TiO₂).

9. The plasma display panel of claim 1, wherein a ratio of the size of the oxide material particles to the size of the phosphor material particles ranges from 0.005 to 1.0.

10. The plasma display panel of claim 9, wherein a ratio of the size of the oxide material particles to the size of the phosphor material particles ranges from 0.05 to 0.25.

11. The plasma display panel of claim 1, wherein the size of the oxide material particles ranges from 20 nm to 3,000 nm.

12. A method of driving a plasma display panel comprising:
supplying a first rising signal with a gradually rising voltage to a scan electrode of the plasma display panel during a reset period of at least one subfield of a frame; and
supplying a second rising signal with a gradually rising voltage, that overlaps the first rising signal, to a sustain electrode of the plasma display panel during the reset period,
wherein the plasma display panel comprises a front substrate including the scan electrode and the sustain electrode that are positioned in parallel to each other, a rear substrate including an address electrode that intersects the scan electrode and the sustain electrode, and a phosphor layer positioned between the front substrate and the rear substrate, the phosphor layer including a phosphor material and an oxide material, particles of the oxide material being positioned between particles of the phosphor material on the surface of the phosphor layer.

13. The method of claim 12, wherein the oxide material includes at least one of magnesium oxide (MgO), zinc oxide (ZnO), silicon oxide (SiO₂), titanium oxide (TiO₂), yttrium oxide (Y₂O₃), aluminum oxide (Al₂O₃), lanthanum oxide (La₂O₃), iron oxide, europium oxide (EuO) or cobalt oxide.

14. The method of claim 12, wherein after the first rising signal is supplied to the scan electrode, a first falling signal with a gradually falling voltage is supplied to the scan electrode during the reset period, and
after the second rising signal is supplied to the sustain electrode, a second falling signal with a gradually falling voltage is supplied to the sustain electrode during the reset period.

15. The method of claim 12, wherein a peak voltage of at least one of the first rising signal or the second rising signal supplied during the reset period of at least one subfield is different from a peak voltage of a first rising signal or a second rising signal supplied in another subfield of the frame.

16. The method of claim 12, wherein a scan signal is supplied to the scan electrode during an address period which follows the reset period, and
wherein a width of the scan signal is different from a width of a scan signal supplied in another subfield of the frame.

17. The method of claim 12, wherein a plurality of sustain signals are supplied to at least one of the scan electrode or the sustain electrode during a sustain period which follows an address period, and
wherein a width of a sustain signal that is first supplied among the plurality of sustain signals is larger than widths of other sustain signals.

18. A plasma display panel comprising:
a front substrate;
a rear substrate that is positioned opposite to the front substrate; and
a means for emitting light based on discharge generated between the front substrate and the rear substrate, the light emitting means positioned between the front substrate and the rear substrate, the light emitting means including particles of phosphor material and particles of oxide material, the oxide material particles being positioned between the phosphor material particles.

19. The plasma display panel of claim 18, wherein the oxide material particles are positioned in the light emitting means in such a manner that illumination at the front surface from at least one phosphor material particle in the light emitting means is unobstructed by the oxide material particles.

20. The plasma display panel of claim 18, wherein a ratio of the size of the oxide material particles to the size of the phosphor material particles ranges from 0.05 to 0.25.

21. The plasma display panel of claim 18, wherein the size of the oxide material particles ranges from 20 nm to 3,000 nm.
